(19) United States
(12) Patent Application Publication
(10) Pub. No.: US 2007/0270099 A1
(43) Pub. Date: Nov. 22, 2007

(54) Method and System for Transmitting Selective Local Information

(75) Inventor: Jacques Le Gars, Gambais (FR)

Correspondence Address: MILLER, MATTHIAS & HULL, ONE NORTH FRANKLIN STREET, SUITE 2350, CHICAGO, IL, 60606, US

(73) Assignee: JC Decaux SA, Neuilly Sur Seine, FR (US)

(21) Appl. No.: 11/748,102

(22) Filed: May 14, 2007

(30) Foreign Application Priority Data
May 17, 2006 (FR) FR 06 04424

(51) Int. Cl. H04B 7/00; H04Q 7/20

(52) U.S. Cl. 455/41.2; 455/517

(57) ABSTRACT

System for transmitting selective local information including information bases suitable for communicating information to mobiles via a short-range radio link The system further comprises configuration bases suitable for establishing a very short-range radio link with the mobiles and for storing, in a memory accessible to the information bases, an address identifying the mobile and personal information which is communicated by the user of the mobile

### FIELD OF THE DISCLOSURE

This invention relates to methods and systems for transmitting selective local information

More particularly, the invention relates to a method for transmitting selective local information including at least one information step during the course of which selective local information (i e, selected, in particular, on the basis of the location of the information base and, where appropriate, on the basis of the mobile ) is communicated from the information bases to at least one mobile by a short-range radio link, by using a predetermined radio communication protocol, said short-range radio link having a nominal range less than 200 m, said information bases communicating with a central server.

### BACKGROUND OF THE DISCLOSURE

The document WO-A-01/89189 describes an example of such a method.

### SUMMARY OF THE DISCLOSURE

This invention has the purpose of further improving the methods of this type, in particular in order to facilitate identification of the users of mobiles To that end, according to the invention, a method of the type in question is characterised in that it further comprises an initial identification step during the course of which:

the mobile is brought near to a configuration base and a very short-range radio link is established between said mobile and said configuration base by using said radio communication protocol, said very short-range radio link having a nominal range less than 2 m,

at least one address identifying the mobile according to said radio communication protocol and personal information (including one or more pieces of information) which is communicated by a use of the mobile, is stored in said central server, said initial identification step being carried out once and for all, prior to any information step

Owing to these arrangements, when the mobile subsequently enters into the area covered by an information base, the address of the mobile is given to the information base when the short-range radio link is established between the mobile and the information base, then said information base can locate the personal information associated with said personal address, and thereby personalise the information transmitted to the mobile

In various embodiments of the method according to the invention, it may be possible to also use one and/or the other of the following arrangements:

the personal information communicated during the identification step includes the type of mobile and, during the information step, the selective local data transmitted to the mobile is formatted on the basis of the type of mobiles;

the personal information communicated during the identification step includes at least one centre of interest of the user of the mobile and, during the information step, the selective local data transmitted to the mobile is based on said centre of interest.

In addition, another object of the invention is a system for transmitting selective local information including information bases suitable for communicating information to at least one mobile by a short-range radio link, by using a predetermined radio communication protocol, said short-range radio link having a nominal range less than 200 m, said information bases communicating with a central server, characterised in that it further comprises at least one configuration base suitable for establishing a very short-range radio link with said mobile by using said radio communication protocol, said very short-range radio link having a nominal range less than 2 m, said configuration base being suitable for storing in the central server at least one address identifying the mobile according to said radio communication protocol and at least one piece of personal information which is communicated by a user of the mobile.

In various embodiments of the system according to the invention, it is also possible to use one and/or the other of the following arrangements:

the very short-range radio link has a nominal range less than 50 cm;

the configuration base is suitable for requesting the user of the mobile to enter said personal information on the mobile and for then downloading this personal information;

the configuration base is suitable for requesting the user of the mobile to enter the type of mobile and for storing the type of mobile in said memory, and the information base is suitable for formatting the selective local data transmitted to the mobile, based on the type of mobile;

the configuration base is suitable for requesting the user of the mobile to enter the type of mobile and for storing the type of mobile in said memory, and the information base is suitable for selecting the selective local data transmitted to the mobile, based on said centre of interest;

the radio communication protocol is chosen from the BLUETOOTH, ZIGBEE AND WI-FI protocols.

### BRIEF DESCRIPTION OF THE DRAWINGS

Other characteristics and advantages of the invention will become apparent during the course of the following description of two of its embodiments, given for non-limiting illustrative purposes, with reference to the attached drawings.

In the drawings:

FIG. 1 is a block diagram of an information transmission system according to a first embodiment of the invention,

FIG. 2 is a perspective view showing an automatic bicycle rental station including an information terminal belonging to the system of FIG. 1,

FIG. 3 is a block diagram of the information terminal of FIG. 2,

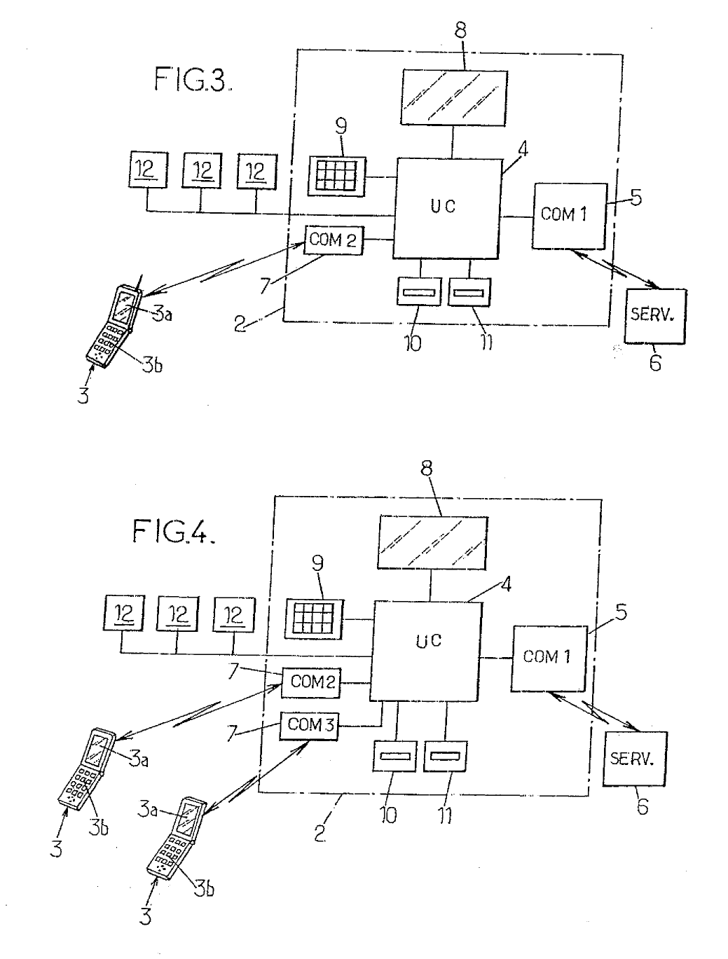

and FIG. 4 is a block diagram similar to FIG. 3, in a second embodiment of the invention

### MORE DETAILED DESCRIPTION

In the various figures, the same references designate identical or similar elements.

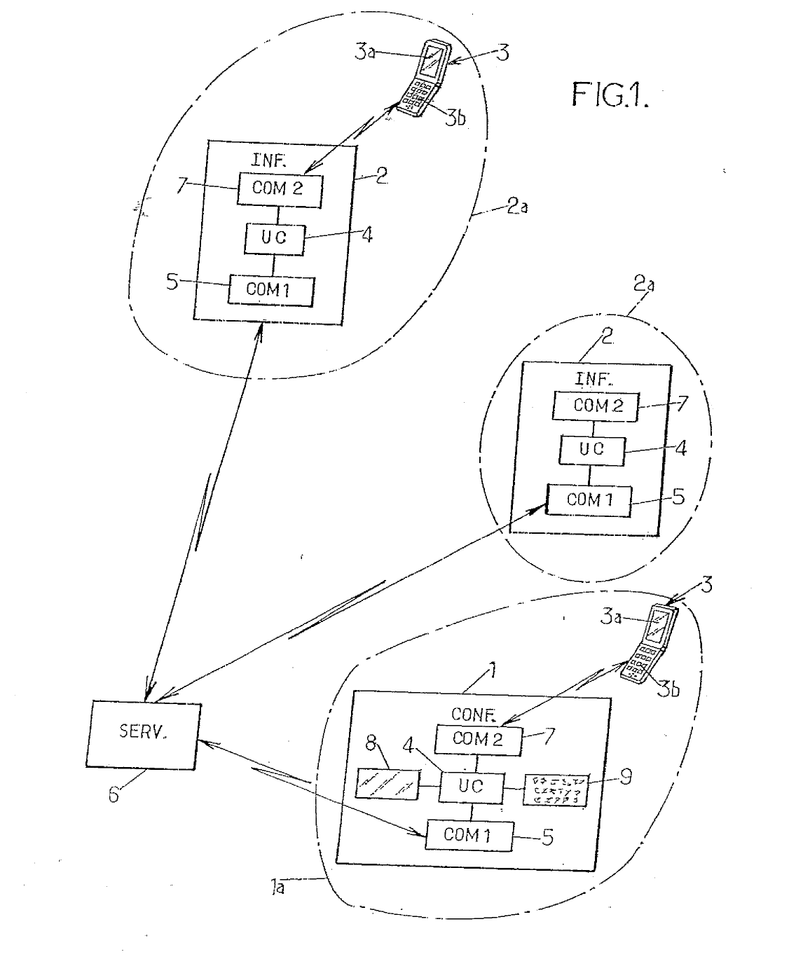

FIG. 1 shows a system for transmitting selective local information, which includes at least one generally stationary configuration base 1 (CONF) (the system according to the invention can preferably include several configuration bases 1) and a plurality of information bases 2 (INF) spread out over a certain land area, e.g., over the land area of a city. Where appropriate, the number of information bases 2 could be reduced to 1, although this configuration is not preferred

Each of the bases 1, 2 is suitable for communicating with a mobile 3 via a radio link, according to a predetermined radio communication protocol, e.g., the BLUETOOTH protocol (IEEE Standard 80215.1) or the ZIGBEE protocol (IEEE Standard 802.154) or possibly the WI-FI protocol (IEEE Standard 802.11).

The configuration base 1 radio link is limited to a very short nominal range (a range defined, for example, under standard conditions), of the order of a few centimetres, in every instance less than 2 m and preferably less than 50 cm (e g., less than 10 cm), while the information bases 2 enable a short-range radio link, with a nominal range of a few dozen metres and generally less than 200 m. The geographic area covered by the very short-range radio link of the configuration terminal 1 is outlined by the boundary la in FIG. 1, and the geographic areas covered by the short-range radio links of the information terminals 2 are outlined by the boundaries 2a in FIG. 1.

The mobiles 3, for example, can be cellular telephones equipped with a short-range radio interface operating according to the aforementioned radio communication protocol (e g., BLUETOOTH or ZIGBEE, as indicated previously), or else, Personal Digital Assistants or any other electronic devices having such a radio link interface and equipped with an output interface such as a screen 3a and an input interface such as a keypad 3b or the like.

The configuration 1 and information 2 bases are themselves electronic devices each including:

an electronic central processing unit 4 (CPU) such as a microprocessor, microcontroller or the like,

a first communication interface 5 (COM 1) connected to the central processing unit 4 and suitable for communicating with a central server 6 (SERV) which, for example, can be common to all of the bases 1, 2 of the land area in question (communication between the bases 1, 2 and the server can be carried out by a wired or radio link),

and a second radio communication interface (COM 2) connected to the central processing unit 4 and suitable for carrying out said radio link, which is very short-range for the configuration base I or short-range for the information bases 2, respectively

The configuration base 1 can further include an output interface such as a screen 8 and an input interface such as a keypad 9, which are connected to the central processing unit 4.

The information transmission system just described functions as follows

When a user wants to be able to receive selective local information, depending, for example, on both the location where they are situated and their personal centres of interest, they proceed with an initial identification step with the information transmission system.

For this purpose, the user brings their mobile 3 within immediate proximity of the configuration terminal 1, so that their mobile 3 can enter into communication with said configuration base 1, via the aforementioned very short-range radio link

As the radio communication protocol is suitable for establishing ad hoc networks, this link is established by itself.

When the link is established, the configuration base receives from the mobile 3 a unique address code identifying this mobile in the radio communication protocol used. If it involves the BLUETOOTH protocol, the address in question is the MAC address. It is noted that, considering the very short range of the radio link, one can be certain the address thus received by the configuration base 1 is that of the collect mobile 3.

Once the radio link has been established between the mobile 3 and the configuration base 1, the configuration base 1 can request personal information from the user of the mobile 3, including one or more pieces of personal information chosen, for example, from:

the type of the mobile (this type being defined, for example, by the manufacturer's brand and the name of the model within the product line of this manufacturer),

one or more centres of interest of the user of the mobile 3.

The aforementioned personal information can be requested from the user by means of the screen 8 of the configuration base, and the user's answers can be provided, for example, by means of the input interface 9 of said configuration base.

It is noted that, according to another alternative, the personal information in question might be entered into the configuration base 1 or directly into the server 6 by a person belonging to a commercial service, after the mobile 3 has entered into communication with the configuration base 1.

When the configuration base 1 has collected the address of the mobile 3 and the aforementioned personal information, it transmits this address and this personal information to the server 6 (in the case where the personal information is entered into the server 6 directly by the sales staff, the configuration base 1 would only communicate the address of the mobile 3 to the server 6).

Once the initial identification step has been completed, the mobile 3 is capable of receiving selective local information from the information bases 2, i.e., information dependent on the location of each information base and/or on the personal information communicated to the server 6 during the identification step.

Thus, each time that the mobile 3 enters within the range 2a of an information terminal 2, an information step occurs, during the course of which the mobile 3 automatically enters into radio communication with the information base 2, according to said aforementioned radio communication protocol. When this communication is established, the information base 2 receives the address that identifies the mobile 3 according to said radio communication protocol and queries the server 6 in order to receive all or part of the personal information corresponding to this address.

Thus, for example, the server 6 can send to the information base 2 the type of mobile 3 and the centres of interest of the user of the mobile 3 The information base 2 then selects the information corresponding to the centres of interest of the user from an information database which is or is not stored locally, and then transmits this information to the mobile 3 via the short-range radio link, in a format compatible with the mobile 3. The user can then consult said information on the screen 3a of their mobile.

It is noted that the information database could be centralised solely on the server 6, in which case, when queried by the information base 2, the server 6 would communicate to it, on the one hand, the type of mobile 3 and, on the other hand, directly, the information corresponding to the cente of interest of the user of the mobile.

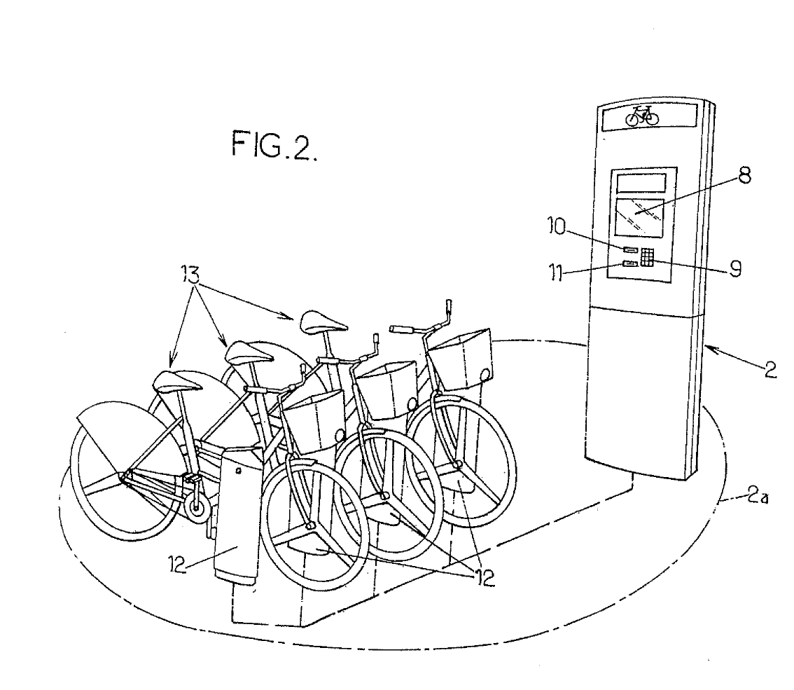

For non-limiting illustrative purposes, an example of an information base 2 has been shown in FIGS. 2 and 3, which, for example, can be in the form of an interactive terminal equipping an automatic bicycle rental station 13. In the example shown in FIG. 2, this interactive terminal includes, in addition to a screen 8 and a keypad 9, an electronic portable card reader 10 such as access cards or payment cards, and a ticket-printing device 11 intended, for example, to confirm a payment or an authorization to deduct from a payment card account.

Besides the interactive terminal 2, the automatic bicycle rental station includes a plurality of locking devices 12 such as posts or the like, onto which the bicycles 13 intended for rental can be locked.

The locking devices 12 can be controlled via the interactive terminal 2, e.g., as described in the document WO-A-02/095698 or in the document WO-A-2006/021650.

Thus, when a user registered in the system for transmitting selective local information borrows a bicycle 13 or returns it, they enter into the range 2a of the information base 2, which range can correspond substantially to the storage area for the bicycles 13 on the locking devices 12.

The mobile 3 of the user then receives, for example, the map of the area with, where appropriate, the closest public transit stations, of information about the monuments or the closest tourist attraction sites to the automatic bicycle rental station, or the like.

If need be, the information terminal 2 can send the information in question, only if it detects the return of a bicycle 13 by it being locked onto its locking device 12, and not when a bicycle 13 is borrowed.

As an alternative, as shown in FIG. 4, the interactive terminal 2 can be equipped with an additional communication interface (COM 3) operating according to said radio communication protocol but having a very short-range, as defined previously for the configuration terminal 1, with the result being that the interactive terminal 2 can then at the same time serve as an information terminal and a configuration terminal.

1. Method for transmitting selective local information including at least one information step during the course of which selective local information is communicated from the information bases to at least one mobile by a short-range radio link, by using a predetermined radio communication protocol, said short-range radio link having a nominal range less than 200 m, said information bases communicating with a central server, said method further comprising an initial identification step during the course of which:
the mobile is brought neat to a configuration base and a very short-range radio link is established between said mobile and said configuration base by using said radio communication protocol, said very short-range radio link having a nominal range less than 2 m,
at least one address identifying the mobile according to said radio communication protocol and personal information (including one or more pieces of information) which is communicated by a use of the mobile, is stored in said central server, said initial identification step being carried out once and for all, prior to any information step.

2. Method of claim 1, in which the personal information communicated during the identification step includes the type of mobile and, during the information step, the selective local data transmitted to the mobile is formatted based on the type of mobile.

3. Method as claimed in claim 1, in which the personal information communicated during the identification step includes at least one centre of interest of the user of the mobile and, during the information step, the selective local data transmitted to the mobile is based on said centre of interest.

4. System for transmitting selective local information including information bases suitable for communicating information to at least one mobile by a short-range radio link, by using a predetermined radio communication protocol, said short-range radio link having a nominal range less than 200 m, said information bases communicating with a central server, said system further comprising at least one configuration base suitable for establishing a very short-range radio link with said mobile by using said radio communication protocol, said very short-range radio link having a nominal range less than 2 m, said configuration base being suitable for storing in the central server at least one address identifying the mobile according to said radio communication protocol and at least one piece of personal information which is communicated by a user of the mobile.

5. System of claim 4, in which the very short-range radio link has a nominal range less than 50 cm

6. System as claimed in claim 4, in which the configuration base is suitable for requesting the user of the mobile to enter said personal information on said mobile and for then downloading said personal information.

7. System of claim 6, in which the configuration base is suitable for requesting the user of the mobile to enter the type of mobile and for storing the type of mobile in said memory, and the information base is suitable for formatting the selective local data transmitted to the mobile, based on the type of mobile.

8. System as claimed in claim 4, in which the configuration base is suitable for requesting the user of the mobile to provide a centre of interest and for storing this centre of interest in said memory, and the information base is suitable for selecting the selective local data transmitted to the mobile, based on said centre of interest.

9. System as claimed in claim 4, in which the radio communication protocol is chosen from the BLUETOOTH, ZIGBEE and WI-FI protocols.
